(19) United States
(12) Patent Application Publication
(10) Pub. No.: US 2025/0308155 A1
(43) Pub. Date: Oct. 2, 2025

(54) SYSTEMS AND METHODS FOR EYE MODELING AND IRIS TEXTURING

(71) Applicant: Electronic Arts Inc., Redwood City, CA (US)

(72) Inventor: Mathieu LAMARRE, Montreal (CA)

(73) Assignee: Electronic Arts Inc., Redwood City, CA (US)

(21) Appl. No.: 18/620,514

(22) Filed: Mar. 28, 2024

(51) Int. Cl. G06T 17/00; G06T 15/00; G06T 15/04; G06V 40/18

(52) U.S. Cl. CPC G06T 17/00; G06T 15/005; G06T 15/04; G06V 40/18; G06T 2219/2016

(57) ABSTRACT

A method for generating a three-dimensional (3D) model of a head is disclosed. One or more images of the head are obtained and the head includes eyes. A parametric model for the eyes that includes a set of parameters is retrieved. Values are assigned for each parameter in the set of parameters of the parametric model for the eyes based on the one or more images. Eye patch areas of areas surrounding the eyes are generated based on the values of the parameters in the set of parameters of the parametric model for the eyes. The 3D model of the head that includes the eyes and the eye patch areas is generated. The eyes are normalized to be spaced a fixed distance apart from one another in the 3D model, and a size of the head in the 3D model is scaled based on the fixed distance between the eyes.

### FIELD

This disclosure generally relates to computer graphics and, more particularly, to system and methods for eye modeling and iris texturing.

### BACKGROUND

In computer-generated graphics applications, such as video games or animated films, characters in the graphics application typically comprise 3D (three-dimensional) character models. In the context of video games, an in-game character model may include hundreds of adjustable parameters. The parameters can be modified to give the in-game character a distinct appearance.

In video game development, it is common to create, maintain, and query a database of high-fidelity models of human heads to be used for game characters. The head models may have different topologies depending on the game title or the source of the head model. For example, the head models may be artist-authored, may come from various scanning techniques, or may use different base shapes as a starting point for manual modeling. The head models may include various head features, such as head width, head height, head shape, etc.

In some implementations, a given head model can be associated with a set of blendshapes. A blendshape, as used herein, is a construct used to deform geometry to create a specific look for a base mesh. A blendshape (e.g., representing different facial expressions or different face shapes having the same topology) may contain multiple “deformed” versions of a base mesh, and blends them together with a neutral version of the base mesh. Blendshapes allow for the base mesh to take on a variety of appearances without needing to create many separate models. The blendshape technique can also be used to create animations by interpolating between blendshapes.

In some instances, a future release of a given game may wish to reuse a character from a prior release of the game, or an entirely different game may wish to reuse a character from another game. However, often a topology of a character model and a set of blendshapes for the character model in the new game may be different than the topology and blendshapes of the character model to be reused. Artists are forced to manually update parameters of the new character model to match the appearance of the character to be reused using the available blendshapes for the new character model, which could have a different topology.

However, manually creating a suitable representation of a custom character that accurately depicts a desired reference character using a different topology and a different set of blendshapes is difficult and time consuming. Some level of artistic competence is usually needed to obtain a good result. In some cases, however, the set of blendshapes available for the new topology may not be sufficient to achieve the desired look, as not every shape may be representable by the set of blendshapes available. In such a case, new blendshapes may need to be created to fill the gap, and is some instances it may not be possible to completely fill the gap due to the limitations of the new mesh topology.

One issue with generating realistic looking human heads are the placement, shape, size, and features that are unique to eyes when compared to the rest of a face of a human head. For example, the diffraction of light through eyes may affect the way an eye looks depending on the lighting included in a scene or where the light source is located. Unrealistic looking eyes can break the immersion a user has when playing a video game. Moreover, the user may not be engaged in the content that includes a character whose eyes are placed incorrectly or acting in a nonrealistic manner (e.g., not focusing on speaking characters, not focusing on objects or the camera, etc.). Incorrectly modeling eyes and the areas around the eyes in a head shape model and failing to account for the unique features of eyes and their movement as the face moves can make the head model look unrealistic. Other problems can be introduced when modeling heads and failing to account for the unique features of the eyes and the areas around the eyes, such as generating an uncanny distortion, blurring of the rendered portion of the head model for the eyes, and creating a final model that includes missing geometry.

### SUMMARY

Embodiments of the disclosure provide a method, computer-readable storage medium, and device for generating a three-dimensional (3D) model of a head. The method includes: obtaining one or more images of the head, wherein the head includes eyes; retrieving a parametric model for the eyes that includes a set of parameters; assigning values for each parameter in the set of parameters of the parametric model for the eyes based on the one or more images; generating eye patch areas of areas surrounding the eyes based on the values of the parameters in the set of parameters of the parametric model for the eyes; and generating the 3D model of the head that includes the eyes and the eye patch areas, wherein the eyes are normalized to be spaced a fixed distance apart from one another in the 3D model, and wherein a size of the head in the 3D model is scaled based on the fixed distance between the eyes.

### BRIEF DESCRIPTION OF THE DRAWINGS

FIG. 1 is a block diagram of a computer system for rendering images, according to aspects of the present disclosure.

FIG. 2 is a block diagram illustrating processor and buffer interaction, according to an embodiment.

FIG. 3 is a conceptual diagram illustrating a head model that is scaled according to a fixed distance between the eyes, according to an embodiment.

FIG. 4 is a conceptual diagram illustrating a parametric eye model with a number of parameters, according to an embodiment.

FIG. 5 is a conceptual diagram illustrating generating models for eyes and eye patch areas from one or more images, according to an embodiment.

FIG. 6 is a conceptual diagram illustrating movement of an eyebag crease area in eye patch area surrounding an eye as the eye moves, according to an embodiment.

FIG. 7 is a conceptual diagram illustrating transforming an iris using polar coordinates and using slices from a diagram of the iris that can be used to generate a texture for the iris, according to an embodiment.

FIG. 8 is a conceptual diagram illustrating refraction of light as it enters the eye generating an offset, according to an embodiment.

FIG. 9 is a conceptual diagram illustrating generation of a texture for an iris with and without differentiable refraction, according to an embodiment.

FIG. 10 is a flow diagram of method steps for generating a three-dimensional (3D) model of a head, according to an embodiment.

### DETAILED DESCRIPTION

The following detailed description is exemplary in nature and is not intended to limit the disclosure or the application and uses of the disclosure. Furthermore, there is no intention to be bound by any expressed or implied theory presented in the preceding technical field, background, summary, brief description of the drawings, or the following detailed description.

As described in greater detail herein, embodiments of the disclosure provide a system and method for generating a 3D model of a head. In some embodiments, a database may be maintained that includes examples of 3D head polygonal meshes with parametric eyes placed using embodiments described herein. The systems and methods described herein may include generating a 3D eye shape for a set of eyes and iris textures for the eyes that include a diffuse color map and a height map.

Generating the 3D model of the head may include normalizing a 3D head mesh database using the eyes' positions, instead of conventional methods which utilize Procrustes analysis. In some embodiments, an eye shape parametric model may be used that is based on spherical coordinates that are different from coordinates or parameters used by conventional models for generating eye shapes for 3D head models. By using the spherical coordinates, the system can keep some coordinates of vertices constant when the eye shape is changed to fit images. The features of the current disclosure may include generating a mesh deformation model of the skin and bone surrounding the eyeball, referred to herein as an eye patch area. In some embodiments, a model for the eye patch area is generated from one or more images while keeping the eye patch consistent with the eye shape. This may include deforming the eyelids to sit on the eyeball. The eye patch area model may be calculated using a set of linear equations. A subset of the eye patch vertices may be constrained to lie on the eyeball using, for example, Catmull-Clark subdivision surface equations while the remaining vertices are constrained with the Smooth-Rotation and As-Rigid-As-Possible equations.

In some embodiments, the eye patch area vertices may first be obtained from a principal component analysis (PCA) shape model and, using linear equations, locations of the vertices may be solved given parameters of the eyeball to obtain the final eye patch area vertex coordinates. In some embodiments, this method may be differentiable in that the gradient of the output can be computed with respect to the input shape model parameters while allowing for gradient descent optimization. A head mesh deformation model may be generated using the generated eye patch model. In some embodiments, the head mesh may be obtained from a PCA shape model. The head mesh deformation model may be determined by blending the two eye patch meshes (areas) using a system of linear equations based on, for example, Laplacian editing. The head mesh deformation model may also be generated in a differentiable manner and the head PCA model parameters may be calculated using gradient descent.

In some embodiments, textures may be generated for the head, eye patch areas, and eyes using differentiable rendering. For example, combining the head, eye patch areas, and eyes may result in a differentiable triangle mesh model that can be rasterized and shaded with a differentiable renderer. In some embodiments, the parameters of the triangle mesh model may be estimated by minimizing the rendered image(s) difference with real images.

The current disclosure also provides solutions for problems associated with rendering eyes. For example, the differentiable rendering of the eyes may use a method to refract light rays. Conventional methods for refracting light rays, including Monte-Carlo methods, perform too slow and have inaccuracies. In some embodiments, the system may compute refraction at a vertex level. For example, the eyes may be subdivided multiple times using, for example, Catmull-Clark equations to get a dense sampling of vertices. View rays may then be refracted according to Snell's law to get an effective iris texture coordinates (i.e., UV coordinates) that are visible at each cornea vertex. Updating each vertex UV coordinates results in a differentiable method of computing refractions for improved rendering of eyes. In some embodiments, the system may model iris diffuse maps and height maps in polar coordinates to transform the disk of an iris to a rectangle and then split the rectangle into small squares that are serve as slices of the iris in Cartesian coordinates. A predictive model of iris slices may be learned with PCA and/or with a variational autoencoder (VAE) that allows spanning of the iris appearance subspace with a compact representation.

For artists working in computer graphics or modeling, the features described herein eliminate the need for manually processing images to generate 3D models of heads including eyes and eye patch areas. Instead, the system can use input images of a head that include eyes. The system can automatically determine eye position and angles, eye shape parameters, iris textures, and a full head geometry where the eye region geometry makes clean contact with the eyeball.

Taking the context of video games as an example, the display of a video game is generally a video sequence presented to a display capable of displaying the video sequence. The video sequence typically comprises a plurality of frames. By showing frames in succession in sequence order, simulated objects appear to move. A game engine typically generates frames in real-time response to user input, so rendering time is often constrained.

As used herein, a “frame” refers to an image of the video sequence. In some systems, such as interleaved displays, the frame might comprise multiple fields or more complex constructs, but generally a frame can be thought of as a view into a computer-generated scene at a particular time or short time window. For example, with 60 frames-per-second video, if one frame represents the scene at t=0 seconds, then the next frame would represent the scene at t= 1/60 seconds or 16 ms. In some cases, a frame might represent the scene from t=0 seconds to t= 1/60 seconds, but in the simple case, the frame is a snapshot in time.

A “scene” comprises those simulated objects that are positioned in a world coordinate space within a view pyramid, view rectangular prism or other shaped view space. In some approaches, the scene comprises all objects (that are not obscured by other objects) within a view pyramid defined by a view point and a view rectangle with boundaries being the perspective planes through the view point and each edge of the view rectangle, possibly truncated by a background.

The simulated objects can be generated entirely from mathematical models describing the shape of the objects (such as arms and a torso described by a set of plane and/or curve surfaces), generated from stored images (such as the face of a famous person), or a combination thereof. If a game engine (or more specifically, a rendering engine that is part of the game engine or used by the game engine) has data as to where each object or portion of an object is in a scene, the frame for that scene can be rendered using standard rendering techniques.

A scene may comprise several objects or entities with some of the objects or entities being animated, in that the objects or entities may appear to move either in response to game engine rules or user input. For example, in a basketball game, a character for one of the basketball players might shoot a basket in response to user input, while a defending player will attempt to block the shooter in response to logic that is part of the game rules (e.g., an artificial intelligence component of the game rules might include a rule that defenders block shots when a shot attempt is detected) and when the ball moves through the net, the net will move in response to the ball. The net is expected to be inanimate, but the players' movements are expected to be animated and natural-appearing. Animated objects are typically referred to herein generically as characters and, in specific examples, such as animation of a football, soccer, baseball, basketball, or other sports game, the characters are typically simulated players in the game. In many cases, the characters correspond to actual sports figures and those actual sports figures might have contributed motion capture data for use in animating their corresponding character. Players and characters might be nonhuman, simulated robots, or other character types.

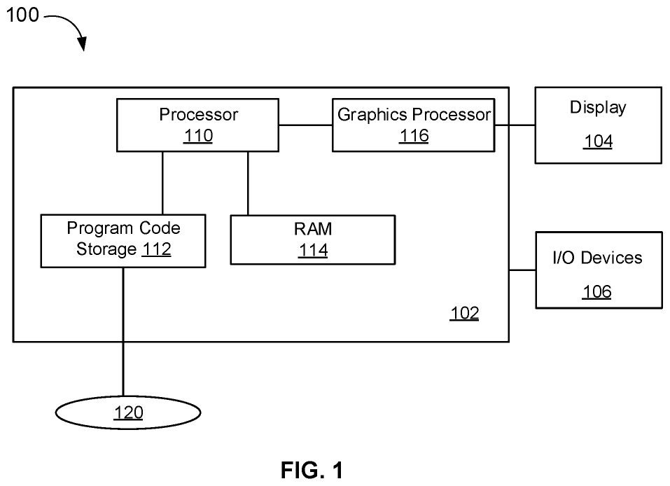

Turning to the drawings, FIG. 1 is a block diagram of a computer system 100 for rendering images, according to aspects of the present disclosure. The computer system 100 may be, for example, used for rendering images of a video game. The computer system 100 is shown comprising a console 102 coupled to a display 104 and input/output (I/O) devices 106. Console 102 is shown comprising a processor 110, program code storage 112, temporary data storage 114, and a graphics processor 116. Console 102 may be a handheld video game device, a video game console (e.g., special purpose computing device) for operating video games, a general-purpose laptop or desktop computer, or other suitable computing system, such as a mobile phone or tablet computer. Although shown as one processor in FIG. 1, processor 110 may include one or more processors having one or more processing cores. Similarly, although shown as one processor in FIG. 1, graphics processor 116 may include one or more processors having one or more processing cores.

Program code storage 112 may be ROM (read only-memory), RAM (random access memory), DRAM (dynamic random access memory), SRAM (static random access memory), hard disk, other magnetic storage, optical storage, other storage or a combination or variation of these storage device types. In some embodiments, a portion of the program code is stored in ROM that is programmable (e.g., ROM, PROM (programmable read-only memory), EPROM (erasable programmable read-only memory), EEPROM (electrically erasable programmable read-only memory), etc.) and a portion of the program code is stored on removable media such as a disc 120 (e.g., CD-ROM, DVD-ROM, etc.), or may be stored on a cartridge, memory chip, or the like, or obtained over a network or other electronic channel as needed. In some implementations, program code can be found embodied in a non-transitory computer-readable storage medium.

Temporary data storage 114 is usable to store variables and other game and processor data. In some embodiments, temporary data storage 114 is RAM and stores data that is generated during play of a video game, and portions thereof may also be reserved for frame buffers, depth buffers, polygon lists, texture storage, and/or other data needed or usable for rendering images as part of a video game presentation.

In one embodiment, I/O devices 106 are devices a user interacts with to play a video game or otherwise interact with console 102. I/O devices 106 may include any device for interacting with console 102, including but not limited to a video game controller, joystick, keyboard, mouse, keypad, VR (virtual reality) headset or device, etc.

Display 104 can any type of display device, including a television, computer monitor, laptop screen, mobile device screen, tablet screen, etc. In some embodiments, I/O devices 106 and display 104 comprise a common device, e.g., a touchscreen device. Still further, in some embodiments, one or more of the I/O devices 106 and display 104 is integrated in the console 102.

In various embodiments, since a video game is likely to be such that the particular image sequence presented on the display 104 depends on results of game instruction processing, and those game instructions likely depend, in turn, on user inputs, the console 102 (and the processor 110 and graphics processor 116) are configured to quickly process inputs and render a responsive image sequence in real-time or near real-time.

Various other components may be included in console 102, but are omitted for clarity. An example includes a networking device configured to connect the console 102 to a network, such as the Internet.

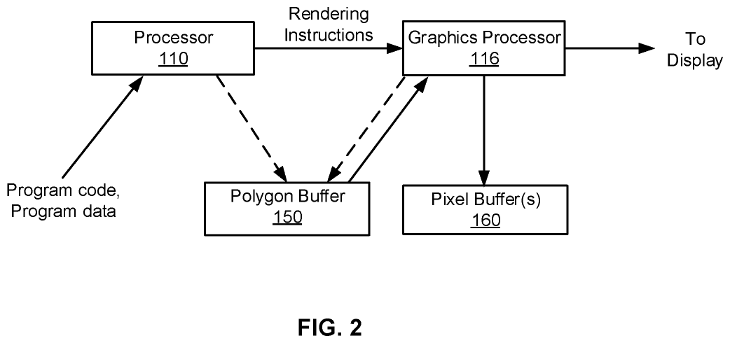

FIG. 2 is a block diagram illustrating processor and buffer interaction, according to one embodiment. As shown in FIG. 2, processor 110 executes program code and program data. In response to executing the program code, processor 110 outputs rendering instructions to graphics processor 116. Graphics processor 116, in turn, reads data from a polygon buffer 150 and interacts with pixel buffer(s) 160 to form an image sequence of one or more images that are output to a display. Alternatively, instead of sending rendering instructions to graphics processor 116 or in addition to sending rendering instructions to graphics processor 116, processor 110 may directly interact with polygon buffer 150. For example, processor 110 could determine which objects are to appear in a view and provide polygon or other mathematical representations of those objects to polygon buffer 150 for subsequent processing by graphics processor 116.

In one example implementation, processor 110 issues high-level graphics commands to graphics processor 116. In some implementations, such high-level graphics commands might be those specified by the OpenGL specification, or those specified by a graphics processor manufacturer.

In one implementation of an image rendering process, graphics processor 116 reads polygon data from polygon buffer 150 for a polygon, processes that polygon and updates pixel buffer(s) 160 accordingly, then moves on to the next polygon until all the polygons are processed, or at least all of the polygons needing to be processed and/or in view are processed. As such, a renderer processes a stream of polygons, even though the polygons may be read in place and be a finite set, where the number of polygons is known or determinable. For memory efficiency and speed, it may be preferable in some implementations that polygons be processed as a stream (as opposed to random access, or other ordering), so that fast, expensive memory used for polygons being processed is not required for all polygons comprising an image.

In some embodiments, processor 110 may load polygon buffer 150 with polygon data in a sort order (if one is possible, which might not be the case where there are overlapping polygons), but more typically polygons are stored in polygon buffer 150 in an unsorted order. It should be understood that although these examples use polygons as the image elements being processed, the apparatus and methods described herein can also be used on image elements other than polygons.

In computer-generated visual content (such as interactive video games), objects may be represented by various computer-generated models, including polygonal meshes and texture maps. A polygonal mesh herein shall refer to a collection of vertices, edges, and faces that define the shape and/or boundaries of a three-dimensional object. A texture map herein shall refer to a projection of an image onto a corresponding polygonal mesh.

Texture mapping provides a method to map colors and other information to pixels from one or more 2D textures to a 3D surface of an object, analogous to “wrapping” a 2D image around the 3D object. In the advent of multi-pass rendering, texture mapping can also include more complex mappings, such as height mapping, bump mapping, normal mapping, displacement mapping, reflection mapping, specular mapping, occlusion mapping, and the like. These techniques make it possible to create near-photorealistic renderings of 3D objects.

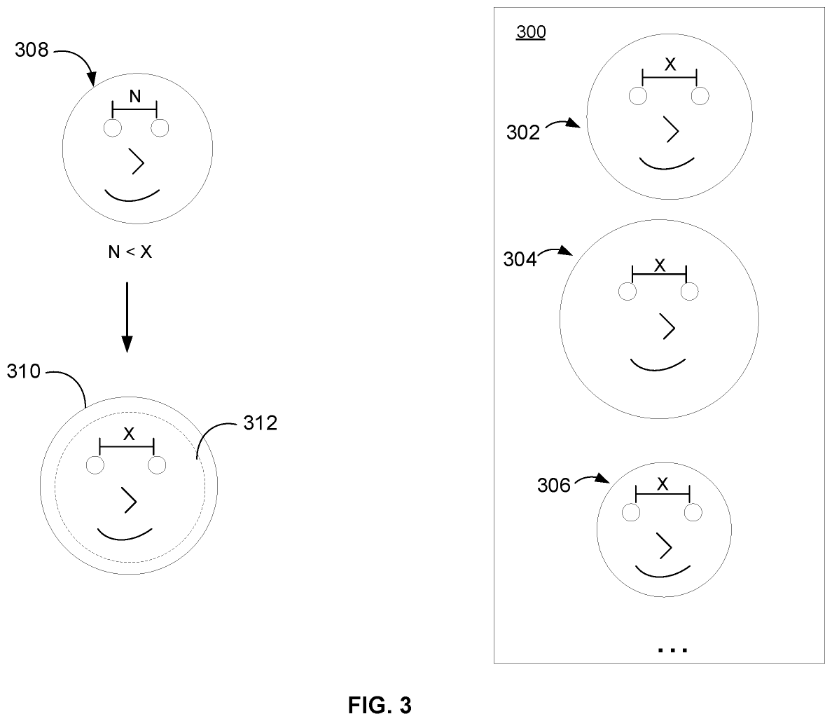

FIG. 3 is a conceptual diagram illustrating a head model that is scaled according to a fixed distance between the eyes, according to an embodiment. FIG. 3 depicts a database 300 of 3D head models 302, 304, 306 that are scaled based on a fixed distance “X” between the eyes. As shown in FIG. 3, even though the heads models in the database 300 have different head sizes (e.g., different head widths), the head models have been normalized to have a fixed distance “X” between the eyes. In some embodiments, the head models 302, 304, 306 may be normalized by using the positions of the eyes at the fixed distance (X) instead of conventional methods that use generalized Procrustes analysis. The fixed distance (X) may be a representation of interpupillary distance between the eyes of the head models 302, 304, 306 in the database 300. In some embodiments, an x-axis may represent a line between eye centers of the eyes of the head models in database 300. In some embodiments, a Gram-Schmidt process may be used to update the y- and z-axes.

In one implementation, Sᵢ and R represent shape tensors (e.g., multi-dimension arrays). For example, if a polygonal mesh has 8000 vertices, Sᵢ and R are [8000, 3] floating point tensors. In one example implementation, Sᵢ is one head shape in the database set {S₀, . . . Sₙ}. An x-axis rotation may be determined that maximizes the mode of T(Sᵢ) with respect to R via a mode pursuit process, where T is linear x-axis rotation transformation. R is set to S₀ on the first iteration, and then set to the average of all registered Sᵢ on each iteration. What changes is how the Sᵢ are registered by a rigid transformation (e.g., rotation, translation, isotropic scale). Maximizing the mode may result in finding a small subset of points to align rigid regions of the head, such as the nose arch or forehead.

FIG. 3 also includes an example of a 3D head model 308 with a distance between the eyes (N) (also referred to herein as “interpupillary distance” or “IPD”) that is less than the fixed distance (X). The head model 308 may be generated from a set of input images or a head capture process. As depicted in FIG. 3, the 3D head model 308 is normalized such that the fixed distance (X) is achieved between the eyes. As shown in FIG. 3, since N<X, a shape 312 of the original head model before normalization is enlarged to shape 310 so that the interpupillary distance of the eyes matches the fixed distance (X). If N were larger than X, then the shape of the original head model would be made smaller so that the interpupillary distance of the eyes matches the fixed distance (X).

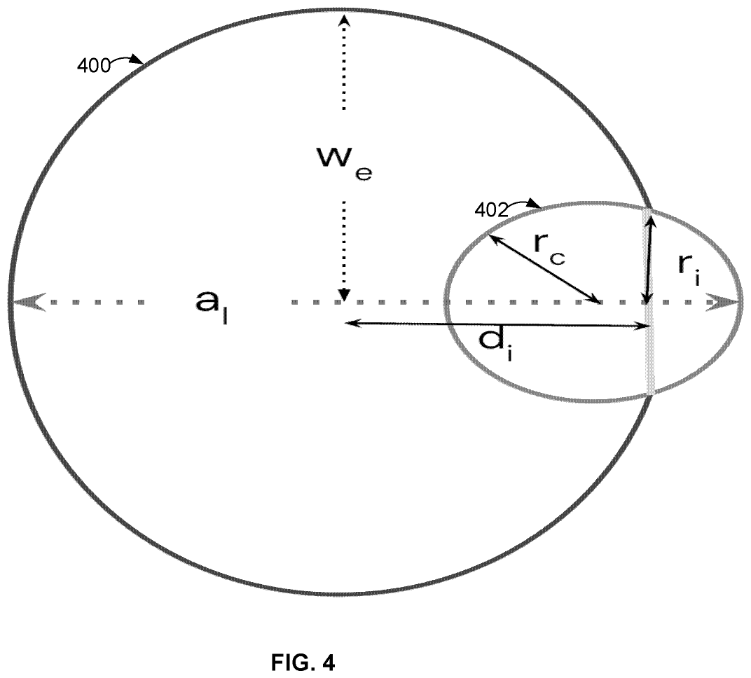

FIG. 4 is a conceptual diagram illustrating a parametric eye model with a number of parameters, according to an embodiment. The parametric eye model of FIG. 4 includes an eye 400 and cornea 402. FIG. 4 also depicts several parameters for the parametric eye model including iris diameter rᵢ (e.g., width to width corneal diameter) for the iris of the eye 400, cornea radius of curvature r_{c}, eye width wₑ, eye axial length aₗ, and iris depth dᵢ.

In one embodiment, the parametric model can be modelled as follows. Let s be the vertices on the unit sphere, and v be the eye model output vertices.

$${r}_{e} = \sqrt{{d}_{i}^{2} + {r}_{i}^{2}}$$

$${d}_{c} = \sqrt{{r}_{c}^{2} - {r}_{i}^{2}} + {d}_{i}$$

$$ACD = {r}_{c} - \sqrt{{r}_{c}^{2} - {r}_{i}^{2}}$$

$$θ = arccos ( {s}^{z} )$$

$$∅ = arctan ( {s}^{y} / {s}^{x} )$$

$${θ}_{e}^{limbus} = arcsin ( {r}_{i} / {r}_{e} )$$

$${θ}_{c}^{limbus} = arcsin ( {r}_{i} / {r}_{c} )$$

$${θ}_{e}^{′} = \{ \begin{matrix}\begin{matrix}\frac{{θ}_{e}^{limbus}}{{θ}^{limbus}} θ \\ \frac{π - {θ}_{e}^{limbus}}{π - {θ}^{limbus}}\end{matrix} & \begin{matrix}( θ - {θ}^{limbus} ) + {θ}_{e}^{limbus} & θ \leq {θ}^{limbus}\end{matrix}\end{matrix} \}$$

$${θ}_{c}^{′} = \{ \begin{matrix}\begin{matrix}\frac{{θ}_{c}^{limbus}}{{θ}^{limbus}} θ \\ \frac{π - {θ}_{c}^{limbus}}{π - {θ}^{limbus}}\end{matrix} & \begin{matrix}( θ - {θ}^{limbus} ) + {θ}_{e}^{limbus} & θ \leq {θ}^{limbus}\end{matrix}\end{matrix} \}$$

$${r}_{e}^{′} = \{ \begin{matrix}smoothinterp ( {r}_{e} , {w}_{e} / 2 , θ ) & {θ}^{limbus} > θ \geq π / 2 \\ smoothinterp ( {w}_{e} / 2 , {a}_{l} - {d}_{i} - ACD , θ ) & π / 2 > θ \geq π\end{matrix} \}$$

$${v}_{e} = [ \begin{matrix}{r}_{e}^{′} cos ( ϕ ) sin ( {θ}_{e}^{′} ) \\ {r}_{e}^{′} sin ( ϕ ) sin ( {θ}_{e}^{′} ) \\ {r}_{e}^{′} cos ( {θ}_{e}^{′} )\end{matrix} ]$$

$${v}_{c} = [ \begin{matrix}{r}_{c} cos ( ϕ ) sin ( {θ}_{c}^{′} ) \\ {r}_{c} sin ( ϕ ) sin ( {θ}_{c}^{′} ) \\ {r}_{c} cos ( {θ}_{c}^{′} ) + {d}_{c}\end{matrix} ]$$

$$α = smoothstep ( 2 ( {θ}_{e}^{′} - {θ}_{e}^{limbus} ) + 0 \text{.5} )$$

$$v = α {v}_{e} + ( 1 - α ) {v}_{c}$$

Some embodiments attempt to keep only measurable parameters:
rᵢ iris diameter
r_{c} cornea radius of curvature
wₑ eye width
a₁ eye axial length
dₗ iris depth
θ_{limbus} depends on the UV set (may be a constant)

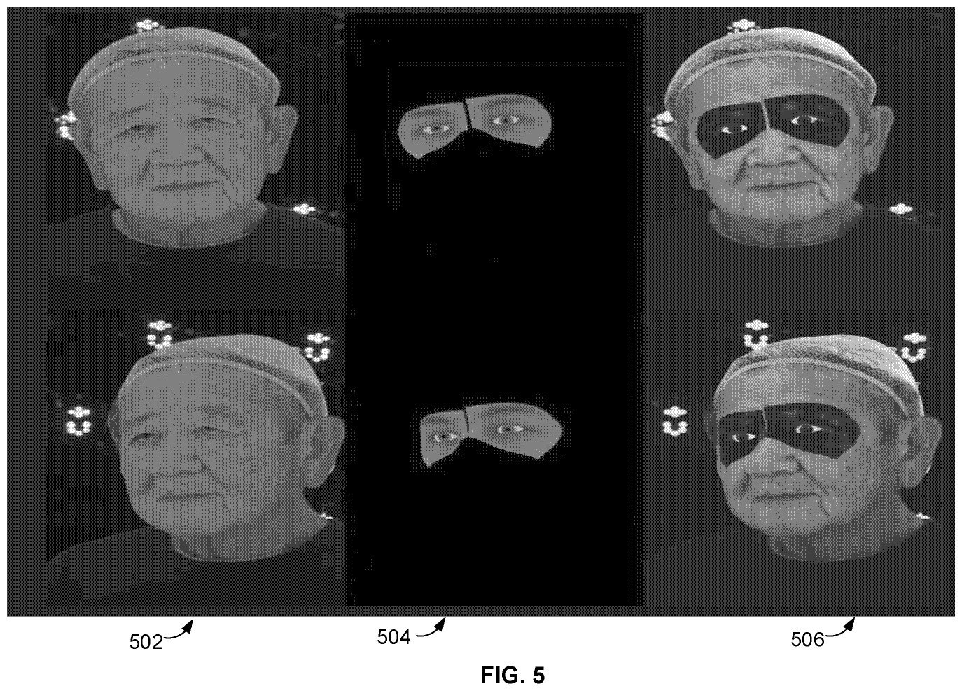

FIG. 5 is a conceptual diagram illustrating generating models for eyes and eye patch areas from one or more images, according to an embodiment. FIG. 5 depicts an initial capture of images at 502 from multiple angles of a head. The parametric model generated using the systems and methods described herein for the eyes and eye patch areas are depicted at 504 from the images at 502. The images at 506 show the extraction of the eye and eye patch area from the images and determined by the features described herein. As depicted, the eye and eye patch areas are generated to conform to multiple angles of a model. From the input images, initial values for the parameters for of the eye model are determined (see FIGS. 3-4). The initial values can be optimized using a predictive model. The interpupillary distance (IPD) is one of the optimized initial values. Dividing the optimized interpupillary distance with the described X fixed distance gives the head scale.

In one implementation, a face landmark detection algorithm can be applied to the images at 502. For example, Google MediaPipe “Face Landmarker” tool can be used to detect face landmarks and facial expressions in images and videos. In some implementations, about 400-500 three-dimensional points of landmarks on the face can be estimates from the images (e.g., 478 point/landmarks in one implementation). In one implementation, the face landmarks include 3-15 points per eye (e.g., 5 points per eye, 10 points for two eyes).

Some embodiments of a head mesh template have UV coordinates per face vertex to allow texture mapping. That means that we have a 2D parametrization of the 3D face, i.e., the face mesh can be unwrapped to a 2D surface for texturing. In some implementations, a correspondence is computed between the face landmarks of the face detection algorithm and the UV coordinates of the head mesh template.

In one implementation, computing the correspondence includes executing a detector algorithm on all frontal camera images in an input database of face images. A screen space UV map for these images is rendered in order to compute, for each person, what was the UV correspondences with each of the face landmark points. Then, some embodiments compute an average of the UV correspondences, which is used for initialization.

The UV coordinates can then be converted to barycentric coordinates (i.e., one barycentric coordinate per face landmark point), which are a triangle index and three real numbers that sum to 1.0. Barycentric coordinates are commonly used in rendering to interpolate attributes.

Given a set of (new) input images, such as at 502 in FIG. 5, initial values for the model parameters can obtained from the input images. Optimization on the initial values can then be performed. Given the initial values of the model parameters, some embodiments can evaluate the 3D position of all vertices. From the vertex positions, we can interpolate the 3D position at the barycentric coordinates with a calibrated pinhole camera model that can compute the projection of the face landmark points. The result is a function to compute the 2D expected image space position of the face landmark points given the head and eyepatch parameters. Some embodiments estimate these parameters to minimize the distance between the positions of the detected face landmark points in the image and the projections.

In one implementation, the head and eye patch parameters includes: principal component analysis (PCA) shape coefficients, a pose of the head in world space (e.g., stored with 6 degrees of freedom: 3 Euler angles and the 3 Cartesian coordinates), and interpupillary distance (IPD). In the head database, the IPD is a fixed distance value (shown as “X” in FIG. 3). Optimizing the IPD and dividing by the fixed distance value X gives the head and eye patch (isotropic) scale.

The PCA shape coefficient are coefficients that multiply the principal vectors of the PCA decomposition of all normalized head and eyepatch shapes in the database.

In one example, each eyeball has five (5) landmark points, including four (4) points on the limbus and one (1) in the middle of the pupil. In one implementation, the UV coordinates of the 5 points on eyeball are fixed and known when the eye texture is designed. The UV coordinates are determined by the size of the iris portion in the eye texture. The eyeball shape and rotation parameters control the positions of the eyeball vertices, which in turn control the 3D positions of the 10 points (i.e., for two eyes) that are also projected on the 2D image with the pinhole camera function. Some embodiments also estimate the parameters to minimize the projection to detection distance for these 10 points.

The remaining face landmark points and the 10 points projection to detection distances for the eyes are summed. This sum is then minimized. The optimization can be done by the L-BFGS algorithm in one embodiment, but it could be done by any gradient based method in other embodiments.

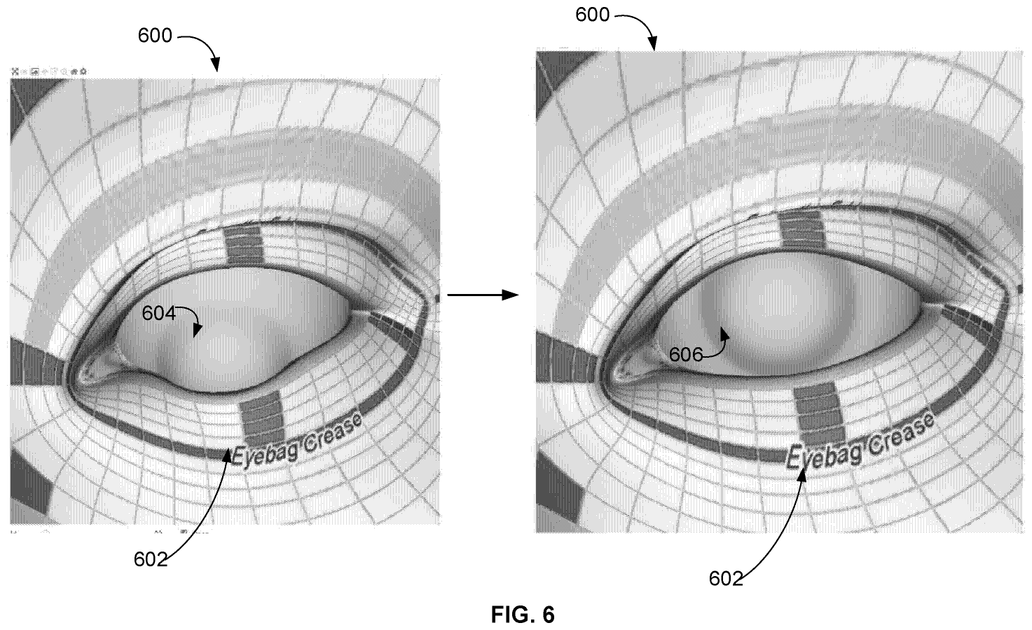

FIG. 6 is a conceptual diagram illustrating movement of an eyebag crease area in eye patch area surrounding an eye as the eye moves, according to an embodiment. FIG. 6 includes a 3D mesh model of an eye an eye patch area 600. In some embodiments, the eye shape parametric model based on spherical coordinates is used to keep the UV texturing coordinates of vertices constant when the eye shape is changed to fit the images. By doing this, the texturing model of the iris is independent of the eye shape and can be optimized independently. In one embodiment, the shape is optimized first with a predictive model and the texture is optimized afterwards. As depicted in FIG. 6, the eye patch area 600 includes an eyebag crease 602 (e.g., eyelid) that deforms in response to movement by the eyeball and cornea at 604 and 606. In some embodiments, the eye patch area 600 may be generated by obtaining initial eye patch vertex locations based on values of parameters of the parametric model for the eyes. The initial eye patch vertex locations may be subdivided into groups and optimized using the Catmull-Clark subdivision surface equations for sharp crease preservation, to keep the eyelid edge sharp.

In one implementation of the eye patch model there are three groups of vertices:
Group A: Vertices that must stay on the eyeball surface;
Group B: Vertices that will deform given Group A and Group C; and
Group C: Vertices that are evaluated using the PCA shape model.

Effectively, Group B deforms given Group A and Group C. Group A is evaluated by the eyeball shape, rotation parameters, eyepatch rigid transform, and IPD. Group C is evaluated by eyepatch PCA coefficients and eyepatch rigid transform and IPD.

In some embodiments, the initial eye patch vertices may be obtained from a PCA shape model of the eye patch area 600 (Group C). A first group of initial eye patch vertex locations that define vertices on the surface of an eyeball (part of Group A), and a second group of initial eye patch vertex locations that define vertices of an eyelid (part of Group B) may be included in the initial eye patch vertex locations. Allowing the eyelid to deform (e.g., change depicted in the eyebag crease 602 due to movement of the eye and cornea at 604 and 606) may include constraining vertices in the first group of initial eye patch vertex locations to approximate the curvature of the eyeball surface evaluated with the parametric model. In some embodiments, the second group of initial eye patch vertex may be interpolated with the Smooth-Rotation equations and As-Rigid-As-Possible equations.

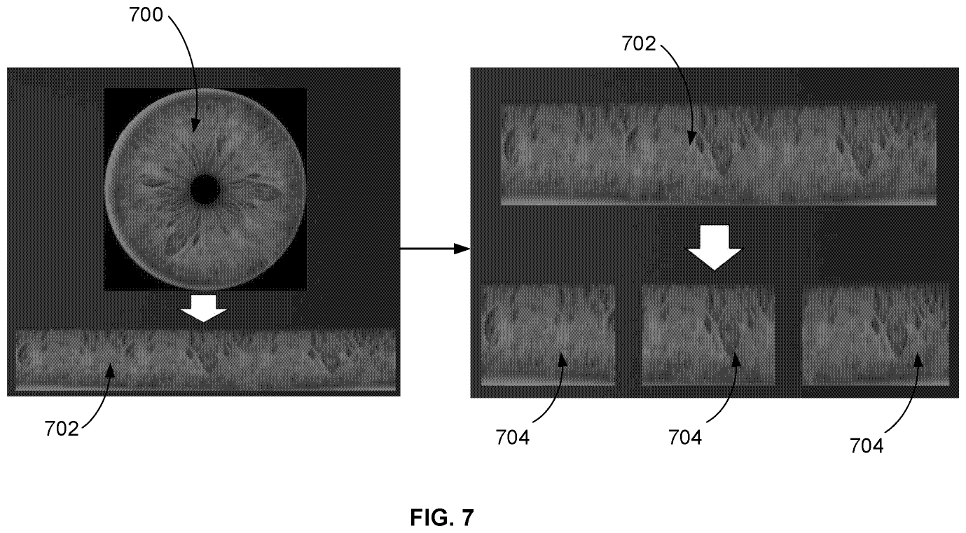

FIG. 7 is a conceptual diagram illustrating transforming an iris using polar coordinates and using slices from a diagram of the iris that can be used to generate a texture for the iris, according to an embodiment. In some embodiments, an image of an iris where the iris is circular 700 is obtained or received. The features described herein include transforming the iris to polar coordinates that can be represented by a rectangle, such as rectangle 702. In some embodiments, a texture for the iris may be generated using polar coordinates. FIG. 7 also depicts the rectangle 702 of the transformed iris 700 being divided into slices 704. In some embodiments, a model to represent the iris may be trained based on the slices 704. By utilizing the rectangle 702 using polar coordinates, no resampling is required during training of the model. Pixels of the texture are not wasted by using polar coordinates as well. This process also allows for rotation of the iris texture, which still produces results as plausible as the original iris image. In some embodiments, the model trained using the slices 704 may be optimized to determine how the slices are assembled using blending functions to generate the texture of the iris 700.

Using a pre-trained iris slice model, some embodiments first assemble rectangle 702 from the model coefficients that are in a 2D tensor (N, C), where N is the number of slices and C is the number of PCA or VAE coefficients. Assembling the rectangle 702 can be done by stacking the N slices horizontally, partially overlapping the N slices on B pixels at overlap borders (for example, 8 pixels), and doing a weighted linear blend on the overlap portion with a smoothing function (for example, sigmoid approximation) for the weights.

In one embodiment, for a case where N=1, the same slice can be repeated to fill rectangle 702 to initialize the iris color quickly.

Transforming rectangle 702 to iris 700 involves polar-to-Cartesian resampling, which can be done with a differentiable function available in any deep learning framework (for example, PyTorch or TensorFlow). Rectangle 702 is then overlaid on the sclera texture using a fixed mask, for example, a white disk on a black background. The mask is fixed since the iris size is fixed in texture space. The sclera texture itself can be obtained, for example, with a [4.4, 3 colors] grid bi-cubic upscaled to 1024×1024×3. Sixteen (16) optimized color points may be constrained to range of whites. The iris over sclera overlay thus gives the eyeball texture.

Going from the (N, C) iris parameters and (16,3) sclera parameters to the eyeball texture is a differentiable function that can be optimized in a differentiable renderer. In practice, the parameters may be optimized coarse to fine. For example, start with N=1 and C=5 to first optimize the overall eye color. Then expand this to N=6 and C=50, by repeating the current value and let the optimization continue. As such, global iris color first is obtained first, and then fine variations second.

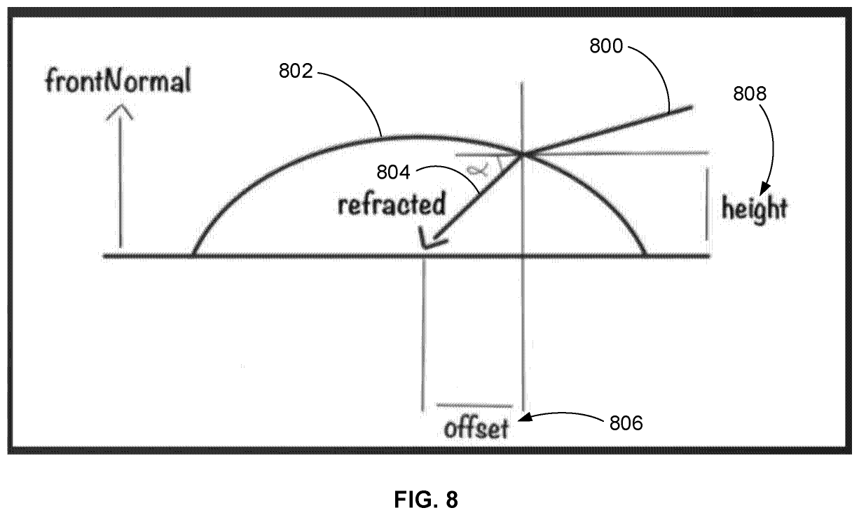

FIG. 8 is a conceptual diagram illustrating refraction of light as it enters the eye generating an offset, according to an embodiment. As depicted in FIG. 8, as light 800 enters the cornea of the eye 802, it refracts 804 thereby creating a texture offset 806.

Height 808 in FIG. 8 is the distance between a point on the cornea and the iris surface. The height is arithmetically computed using the eyeball shape model at each cornea vertex to compute a texture space offset. The cornea can be subdivided with the Catmull-Clark process to have a dense vertex mesh for accurate texture space remapping.

In some embodiments, more realism can be achieved by adding parallax mapping to use the height map to change the texture coordinates a bit more. Doing so affects the shading of the iris to give it more 3D texture.

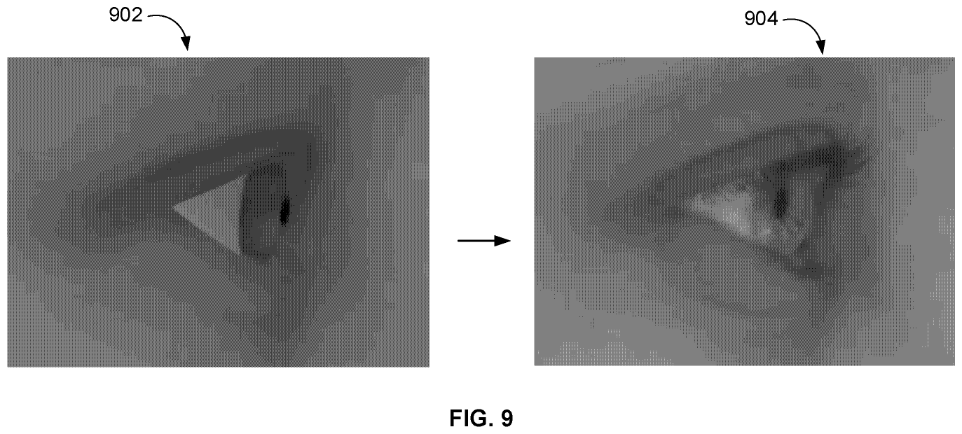

FIG. 9 is a conceptual diagram illustrating generation of a texture for an iris with and without differentiable refraction, according to an embodiment. As depicted in FIG. 9, a texture 902 generated for an iris without differentiable refraction at 902 lacks definition, depth, and proper color depiction or interaction with light. Also depicted in FIG. 9 is a texture 904 for an iris generated using differentiable refraction, which includes more definition, depth, appropriate colors, and appropriately reacts to interactions with light. The texture 904 appears more curved and less flat than the texture 902. As described herein, the texture 904 may be generated using differentiable refraction by subdividing the cornea to generate multiple vertices. View rays interacting with the cornea may be refracted at each vertex to compute UV coordinates with gradients. In some embodiments a differentiable renderer updates UV gradients which may back-propagate to vertices for the eye. An example differential renderer is Nvdiffrast, which is a PyTorch/TensorFlow library that provides high-performance primitive operations for rasterization-based differentiable rendering.

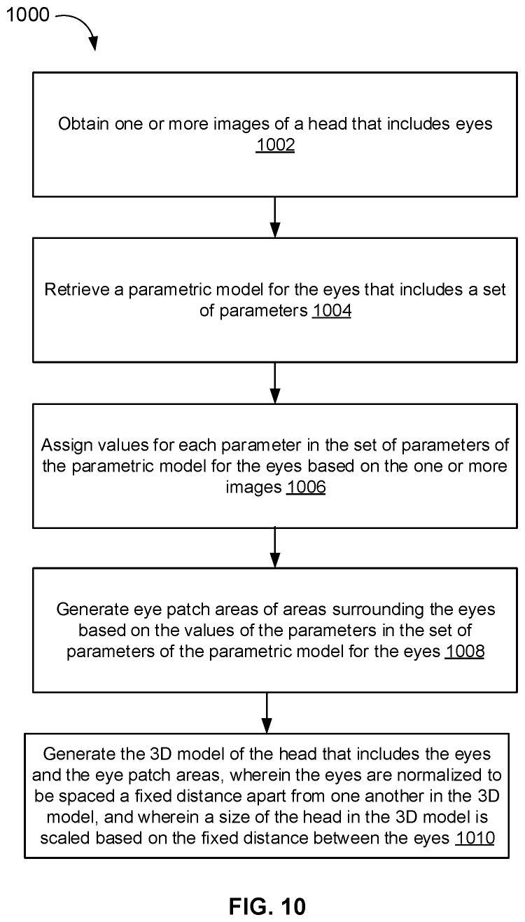

FIG. 10 is a flow diagram of method steps for generating a three-dimensional (3D) model of a head, according to an embodiment. In various implementations, the method can be performed by the processor 110, the graphics processor 116, or a combination of the processor 110 and the graphics processor 116.

The method begins at step 1002, where a processor obtains one or more images of a head that includes eyes. The images may be captured via calibrated or uncalibrated cameras, from multiple angles, and/or under multiple lighting conditions. The images may be accessed and stored on a database.

At step 1004, the processor retrieves a parametric model for the eyes that includes a set of parameters. In some embodiments, the set of parameters of the parametric model for the eyes includes parameters for iris diameter, cornea radius of curvature, eye width, eye axial length, and iris depth.

At step 1006, the processor assigns values for each parameter in the set of parameters of the parametric model for the eyes based on the one or more images. Assigning the values for each parameter in the set of parameters may include obtaining an initial set of parameter values for the set of parameters of the parametric model for the eyes based on the one or more images, and assigning the values for each parameter in the set of parameters of the parametric model by performing gradient descent on the initial set of parameter values to optimize the parameter values.

At step 1008, the processor generates eye patch areas of areas surrounding the eyes based on the values of the parameters in the set of parameters of the parametric model for the eyes. The eye patch areas may be generated using a gradient descent algorithm applied to raw data from the one or more images and eye data from a database on heads. Each head in the database of heads may include eyes, and the eyes of each head in the database of heads may be normalized to be spaced the fixed distance apart from one another for each head. In one embodiment, generating the eye patch areas includes obtaining initial eye patch vertex locations based on the values of the parameters in the set of parameters of the parametric model for the eyes, subdividing the initial eye patch vertex locations into groups, and generating the eye patch areas based on optimizing the initial eye patch vertex locations using Catmull-Clark subdivision surface equations.

At step 1010, the processor generates the 3D model of the head that includes the eyes and the eye patch areas. The eyes may be normalized to be spaced a fixed distance apart from one another in the 3D model. A size of the head in the 3D model may be scaled based on the fixed distance between the eyes.

In one embodiment, the fixed distance between the eyes to which the eyes of each head in the database of heads are normalized is calculated by computing an average eye spacing for the heads in the database before normalization of the eye spacing to the fixed distance for each head. In one embodiment, an iris texture for an iris of the eyes is generated. The iris may be modeled using polar coordinates. In one embodiment, an image of an iris may be received where the iris is circular. The iris may be transformed to polar coordinates which may be represented by a rectangle. A texture for the iris may be generated based on the polar coordinates.

In one embodiment, the rectangle that represents the iris transformed to polar coordinates may be divided into slices. A model may be trained to represent the iris based on the slices of the rectangle that represent the iris transformed to polar coordinates. In one embodiment, the texture for the iris may include a diffuse color map and a height map for the eyes. In one embodiment, an image of the 3D model of the head may be rendered using differential rendering.

In some embodiments, some vertices of initial eye patch vertex locations can be constrained to approximate the curvature of the eyeball surface evaluated with the parametric model. In some embodiments, vertices of a cornea of an eye of the 3D model may be subdivided to obtain a dense sampling of vertices of the cornea. Refraction values for the cornea may be computed based on the dense sampling of vertices. The cornea may be rendered based on applying a texture to vertices of the cornea and the refraction values for the cornea.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and are believed to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A method for generating a three-dimensional (3D) model of a head, the method comprising:
obtaining one or more images of the head, wherein the head includes eyes;
retrieving a parametric model for the eyes that includes a set of parameters;
assigning values for each parameter in the set of parameters of the parametric model for the eyes based on the one or more images;
generating eye patch areas of areas surrounding the eyes based on the values of the parameters in the set of parameters of the parametric model for the eyes; and
generating the 3D model of the head that includes the eyes and the eye patch areas, wherein the eyes are normalized to be spaced a fixed distance apart from one another in the 3D model, and wherein a size of the head in the 3D model is scaled based on the fixed distance between the eyes.

2. The method of claim 1, wherein the set of parameters of the parametric model for the eyes includes the parameters for iris diameter, cornea radius of curvature, eye width, eye axial length, and iris depth.

3. The method of claim 1, wherein the eye patch areas are generated using a gradient descent algorithm applied to raw data from the one or more images and eye data from a database of heads, wherein each head in the database of heads includes eyes, and wherein the eyes of each head in the database of heads are normalized to be spaced the fixed distance apart from one another for each head.

4. The method of claim 3, further comprising calculating the fixed distance between the eyes to which the eyes of each head in the database of heads are normalized by computing an average eye spacing for the heads in the database before normalization of the eye spacing to the fixed distance for each head.

5. The method of claim 1, wherein assigning the values for each parameter in the set of parameters of the parametric model for the eyes based on the one or more images comprises:
obtaining an initial set of parameter values for the set of parameters of the parametric model for the eyes based on the one or more images; and
assigning the values for each parameter in the set of parameters of the parametric model by performing gradient descent on the initial set of parameter values to optimize the parameter values.

6. The method of claim 1, further comprising generating an iris texture for an iris of the eyes, wherein the iris is modeled using polar coordinates.

7. The method of claim 1, further comprising:
receiving an image of an iris, wherein the iris is circular;
transforming the iris to polar coordinates, wherein the iris transformed to polar coordinates can be represented by a rectangle; and
generating a texture for the iris based on the polar coordinates.

8. The method of claim 7, further comprising:
dividing the rectangle that represents the iris transformed to polar coordinates into slices; and
training a model to represent the iris based on the slices of the rectangle that represent the iris transformed to polar coordinates.

9. The method of claim 7, wherein the texture for the iris includes a diffuse color map and a height map for the eyes.

10. The method of claim 1, further comprising rendering an image of the 3D model of the head using differential rendering.

11. The method of claim 1, wherein generating the eye patch areas comprises:
obtaining initial eye patch vertex locations based on the values of the parameters in the set of parameters of the parametric model for the eyes;
subdividing the initial eye patch vertex locations into groups; and
generating the eye patch areas based on optimizing the initial eye patch vertex locations using Catmull-Clark subdivision surface equations.

12. The method of claim 11, wherein a first group of initial eye patch vertex locations defines vertices of an eyelid and a second group of initial eye patch vertex locations defines vertices of an eyeball, and wherein optimizing the initial eye patch vertex locations comprises constraining vertices in the first group of initial eye patch vertex locations that defines vertices of the eyelid to approximate a curvature of the vertices in the second group of initial eye patch vertex locations that defines vertices of the eyeball.

13. The method of claim 1, further comprising:
subdividing vertices of an iris of an eye in the 3D model to obtain a dense sampling of vertices of the iris;
computing refraction values for the iris based on the dense sampling of vertices; and
rendering the iris based on applying a texture to vertices of the iris and the refraction values for the iris.

14. A non-transitory computer-readable storage medium storing instructions that, when executed by one or more processors, cause a computing device to generate a three-dimensional (3D) model of a head, by performing operations comprising:
obtaining one or more images of the head, wherein the head includes eyes;
retrieving a parametric model for the eyes that includes a set of parameters;
assigning values for each parameter in the set of parameters of the parametric model for the eyes based on the one or more images;
generating eye patch areas of areas surrounding the eyes based on the values of the parameters in the set of parameters of the parametric model for the eyes; and
generating the 3D model of the head that includes the eyes and the eye patch areas, wherein the eyes are normalized to be spaced a fixed distance apart from one another in the 3D model, and wherein a size of the head in the 3D model is scaled based on the fixed distance between the eyes.

15. The non-transitory computer-readable storage medium of claim 14, wherein the set of parameters of the parametric model for the eyes includes parameters for iris diameter, cornea radius of curvature, eye width, eye axial length, and iris depth.

16. The non-transitory computer-readable storage medium of claim 14,
wherein the eye patch areas are generated using a gradient descent algorithm applied to raw data from the one or more images and eye data from a database of heads, wherein each head in the database of heads includes eyes, and wherein the eyes of each head in the database of heads are normalized to be spaced the fixed distance apart from one another for each head.

17. The non-transitory computer-readable storage medium of claim 16, further comprising calculating the fixed distance between the eyes to which the eyes of each head in the database of heads are normalized by computing an average eye spacing for the heads in the database before normalization of the eye spacing to the fixed distance for each head.

18. A device for generating a three-dimensional (3D) model of a head, the device comprising:
a memory storing instructions; and
one or more processors configured to execute the instructions to cause the device to:
obtain one or more images of the head, wherein the head includes eyes;
retrieve a parametric model for the eyes that includes a set of parameters;
assign values for each parameter in the set of parameters of the parametric model for the eyes based on the one or more images;
generate eye patch areas of areas surrounding the eyes based on the values of the parameters in the set of parameters of the parametric model for the eyes; and
generate the 3D model of the head that includes the eyes and the eye patch areas, wherein the eyes are normalized to be spaced a fixed distance apart from one another in the 3D model, and wherein a size of the head in the 3D model is scaled based on the fixed distance between the eyes.

19. The device of claim 18, wherein the set of parameters of the parametric model for the eyes includes parameters for iris diameter, cornea radius of curvature, eye width, eye axial length, and iris depth.

20. The device of claim 18, wherein the eye patch areas are generated using a gradient descent algorithm applied to raw data from the one or more images and eye data from a database of heads, wherein each head in the database of heads includes eyes, and wherein the eyes of each head in the database of heads are normalized to be spaced the fixed distance apart from one another for each head.
